(19) United States
(12) Patent Application Publication
(10) Pub. No.: US 2007/0233865 A1
(43) Pub. Date: Oct. 4, 2007

(54) Dynamically Adjusting Operating Level of Server Processing Responsive to Detection of Failure at a Server

(76) Inventors: Zachary A. Garbow, Rochester, MN (US); Robert H. Hamlin, Mantorville, MN (US); Clayton L. McDaniel, Rochester, MN (US); Kenneth J. Trisko, Stewartville, MN (US)

Correspondence Address: IBM CORPORATION;DEPARTMENT 417, 3605 HIGHWAY 52 NORTH, ROCHESTER, MN, 55901-7829, US

(21) Appl. No.: 11/278,019

(22) Filed: Mar. 30, 2006

(51) Int. Cl. G06F 15/173

(52) U.S. Cl. 709/226

(57) ABSTRACT

A facility is provided for dynamically adjusting operating level of server processing within a computing environment including one or more servers processing multiple types of server tasks. The facility includes, responsive to detection of a failure at a server of the environment, determining a situational severity threshold for continued computing environment task processing, and automatically comparing the threshold against priority metrics for the multiple types of server tasks processed within the environment. Server processing of one or more types of server tasks having a priority metric below the situational severity threshold is then automatically blocked. The facility can also include dynamically adjusting of at least one priority metric associated with at least one type of server task to reflect a cause of the failure of the server, wherein the dynamically adjusting occurs prior to the automatic comparing of the situational severity threshold against the priority metrics.

### CROSS-REFERENCE TO RELATED APPLICATION

This application contains subject matter which is related to the subject matter of the following co-filed, commonly assigned application, which is hereby incorporated herein by reference in its entirety:

“Transitioning of Database Service Responsibility Responsive to Server Failure in a Partially Clustered Computing Environment”, by Garbow et al., U.S. Ser. No. ______, co-filed herewith (Attorney Docket No.: ROC920050486US1).

### TECHNICAL FIELD

The present invention relates in general to server processing within a computing environment, and in particular, to a facility for dynamically adjusting the operating level of server processing within a computing environment responsive to detection of a failure at a server of the computing environment.

### BACKGROUND OF THE INVENTION

A computing environment wherein multiple servers have the capability of sharing resources is referred to as a cluster. A cluster may include multiple operating system instances which share resources and collaborate with each other to process system tasks. Various cluster systems exist today, including, for example, the RS/6000 SP system offered by International Business Machines Corporation.

A cluster environment is typically a very safe processing environment. However, once one server within a two server cluster fails, the remaining server is actually less stable than a single server in a non-clustered environment. This is because failover causes additional load to be handed over to the remaining server suddenly. Further, when failover occurs, it is often more essential that the remaining server not fail, leaving an entire cluster of users without access to the computing environment.

Additionally, high availability environments can have a single problem perpetuate through a network of clustered servers. For example, a corrupt file or memo that causes a first server in the cluster to fail can often work its way through subsequent servers and cause additional failures on the clustered (i.e., backup) servers that are in place to maintain availability of the system.

Thus, there remains a need, responsive to failure at a server, for techniques to provide enhanced assurance that one or more servers of a computing environment can continue to process tasks, and do not themselves fail.

### SUMMARY OF THE INVENTION

The shortcomings of the prior art are overcome and additional advantages are provided through the provision of a method of dynamically adjusting operating level of server processing within a computing environment, the computing environment including one or more servers processing multiple types of server tasks. The method includes: responsive to detecting failure at a server of the computing environment, automatically determining a situational severity threshold for continued computing environment task processing; comparing the situational severity threshold with priority metrics for the multiple types of server tasks processed by the computing environment; and blocking server processing of one or more types of server tasks having a priority metric below the situational severity threshold.

In other aspects, the method further includes dynamically adjusting at least one priority metric associated with at least one type of server task of the multiple types of server tasks to reflect a cause of the failure at the server, the dynamically adjusting occurring prior to the comparing and the blocking. In a further aspect, the blocking includes determining whether the server having the failure is part of a cluster, and if so, shutting down a backup server's processing of tasks with priority metrics below the situational severity threshold. Otherwise, notifying the server having the failure to block processing of tasks with priority metrics below the situational severity threshold, and continuing restricted task processing at the server having the failure.

In another aspect, a system of adjusting operating level of server processing within a computing environment is provided. The computing environment includes one or more servers processing multiple types of server tasks. The system includes: means for determining a situational severity threshold for continued computing environment task processing by the one or more severs responsive to detecting failure at a server of the computing environment; means for comparing the situational severity threshold with priority metrics, each priority metric being associated with a different type of server task of the multiple types of server tasks processed by the computing environment; and means for blocking processing of one or more types of server tasks having a priority metric below the situational severity threshold.

In a further aspect, at least one program storage device readable by a computer, tangibly embodying at least one program of instructions executable by the computer to perform a method of adjusting operating level of server processing within a computing environment is provided. The computing environment includes one or more servers processing multiple types of server tasks. The method performed includes: responsive to detecting failure at a server of the computing environment, determining a situational severity threshold for continued computing environment task processing; comparing the situational severity threshold with priority metrics for the multiple types of server tasks processed by the computing environment; and blocking server processing of one or more types of server tasks having a priority metric below the situational severity threshold.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a computing environment to incorporate and use one or more aspects of the present invention;

FIG. 2 depicts another embodiment of a computing environment, which includes a plurality of clusters, at least one of which incorporates and uses one or more aspects of the present invention; and

FIG. 3 depicts one embodiment of logic for dynamically adjusting operating level of server processing responsive to detection of a failure at a server, in accordance with one or more aspects of the present invention.

### BEST MODE FOR CARRYING OUT THE INVENTION

Generally stated, provided herein is an automatic facility for dynamically adjusting operating level of server processing within a computing environment comprising one or more servers processing multiple types of server tasks. The phrase “server task” means any program, task or process running in support of server functionality. For example, a mail server might have a mail routing task, index update task, calendar task, web mail task, virus scanning task, etc.

The facility includes, responsive to detecting failure at a server of the computing environment, determining a situational severity threshold for continued computing environment task processing.

The phrase “situational severity threshold” refers to a number or value employed to rate the significance of a failure(s) in comparison to the importance of maintaining the server, or portions of the server functioning. The number or value can be abstracted into a percentile from 0 to 100, to use one example. The value may be calculated (or re-calculated) at any point in time based on administrator-weighted factors. For example, the value may be periodically calculated to allow for dynamic adjustment in the server processing as conditions change. By way of example, the administrator-weighted factors may include: (1) time of day; (2) number of users; (3) server service level attainment (SLA) metrics or availability goals; and (4) required resources for each type of task processing (e.g., CPU, memory, etc.).

Next, the facility compares the situational severity threshold with priority metrics for the multiple types of server tasks processed by the computing environment. The priority metrics may be set forth in a task priority list. A “task priority list” is a simple ranking or prioritization of the importance of various types of server tasks. The administrator may initially specify within the computing environment configuration (e.g., task priority list) the importance of each type of server task to be processed.

The facility then blocks server processing of one or more types of server tasks having a priority metric(s) below the situational severity threshold.

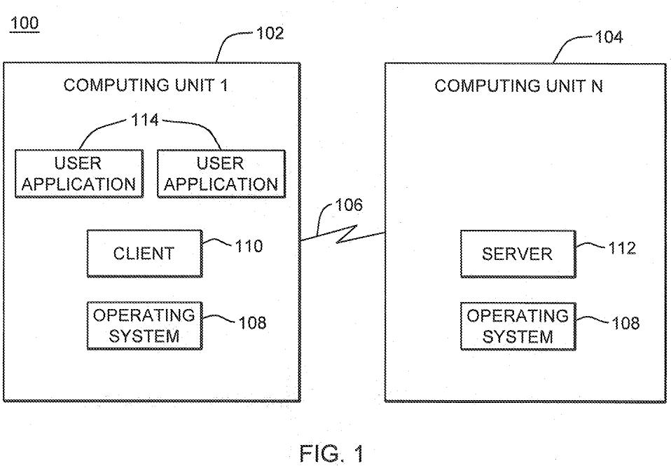

This facility for dynamically adjusting operating level of server processing is applicable to different types of computing environments, two examples of which are provided in FIGS. 1 & 2.

FIG. 1 depicts a computing environment 100 which includes, for instance, a computing unit 102 coupled to another computing unit 104 via a connection 106. A computing unit includes, for example, a personal computer, a laptop, a workstation, a mainframe, a mini-computer, or any other type of computing unit. Computing unit 102 may or may not be the same type of unit as computing unit 104. The connection coupling the units is a wire connection or any type of network connection, such as a local area network (LAN), a wide area network (WAN), a token ring, an Ethernet connection, an internet connection, etc.

In one example, each computing unit executes an operating system 108, such as, for instance, the z/OS operating system, offered by International Business Machines Corporation, Armonk, N.Y.; a UNIX operating system; Linux; Windows; or any other operating systems. The operating system of one computing unit may be the same or different from another computing unit. Further, in other examples, one or more of the computing units may not include an operating system.

In one embodiment, computing unit 102 includes a client application (a/k/a, a client) 110 which is coupled to a server application (a/k/a, a server) 112 on computing unit 104. As one example, client 110 communicates with server 112 via, for instance, a Network File System (NFS) protocol over a TCP/IP link coupling the applications. Further, on at least one computing unit, one or more user applications 114 are executing.

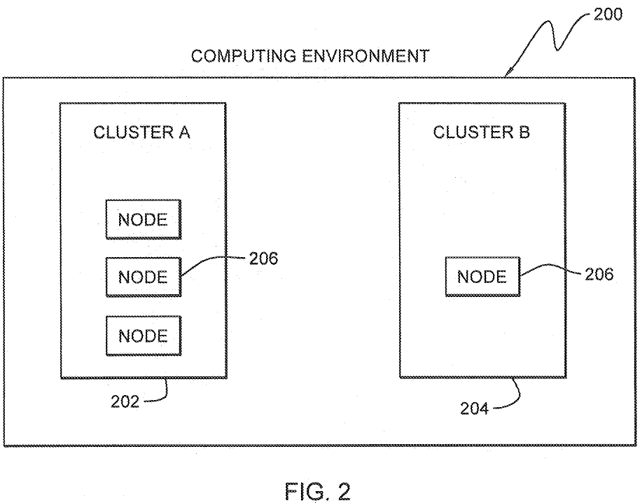

As a variation, computing unit 104 of FIG. 1 could be a standalone computing unit comprising a computing environment with only one server. The facility described herein applies equally to this environment as well as to a networked environment such as depicted in FIG. 1, or a clustered environment as shown in FIG. 2.

As noted, a computing environment which has the capability of sharing resources is termed a cluster. In particular, a computing environment to incorporate and use one or more aspects of the present invention can include one or more clusters. For example, as shown in FIG. 2, a computing environment 200 includes two clusters: Cluster A 202 and Cluster B 204. Each cluster includes one or more nodes (e.g., servers) 206, which share resources and collaborate with each other in performing system tasks. Each node (or server) includes an individual copy of the operating system.

As a further variation, a single cluster of the computing environment of FIG. 2 may comprise two nodes, a principal processing node (or server), and a backup node (or server), wherein when failure is detected at the principal node, task processing is automatically transitioned to the backup node. The facility described hereinbelow is described, by way of example, with reference to such a computing environment configuration.

In accordance with an aspect of the present invention, once a failure at one server within a clustered pair of servers is identified, the clustered server or backup server adjusts to run in a reduced-risk or “safe mode” by blocking, i.e., shutting down or delaying, certain non-essential types of tasks. While in an operational mode in which a failure has occurred in one server of the cluster, it is deemed acceptable herein to run the backup server in a mode of reduced functionality. This is to allow users to still be able to execute critical functionality, such as access to mail and data, and thereby allow failure at the principal server to go unnoted by the majority of end users.

As one example, a clustered backup server maintains an awareness of the health and well-being of its cluster partner server(s), using, e.g., the Tivoli Monitoring 5.1 for Messaging and Collaboration and/or the Tivoli Monitoring 5.1 for Web Infrastructure products offered by International Business Machines Corporation. Upon noticing that it has lost a session with its partner server(s), the backup server automatically reduces or suspends operation of non-essential tasks in a manner as described herein. For example, different types of tasks are preconfigured to indicate an approximate CPU, memory, and bandwidth utilization, along with a priority metric indicating the significance of the task type. Upon failover to the backup server, based on this configuration, the server suspends appropriate types of tasks to effectively stabilize its resource allocation, e.g., to meet an impending increase of users.

Based on the number of failures, the number of users failing over, or the probability that another failure could occur, the backup server can dynamically adjust which types of server tasks and how many types of server tasks will be suspended. For example, first failure data capture could be employed to inform the remaining or backup cluster server(s) of the failing task(s). If this information exists, it could be employed to assist the remaining servers in determining which type of task actually failed, and caused the first server to crash. The remaining cluster server(s) could then shut down the same task type in an attempt to isolate the problem and prevent the problem from reoccurring within the cluster.

By way of specific example, in a Lotus Notes/Domino 7 environment, offered by International Business Machines Corporation, a typical mail server runs more than a dozen types of tasks. Few of the processes are essential for running the server or accessing data over a relatively short period of time, e.g., three hours or less. Instead, most provide additional functionality on top of the server's main task(s). For example, a typical mail server might process multiple types of server tasks relating to its function, including: Agent Manager; SCHED (calendaring function); Collect (administrative statistic/data); ADMINP (administration/user id functions); CLREP (cluster administration functions); Index (performance process for view indexes); Router (mail delivery); SMTP (internet mail delivery); and other cluster processes. By blocking or suspending one or more target tasks upon failover, the server can gain better performance and stability over the short term at the expense of the added functionality.

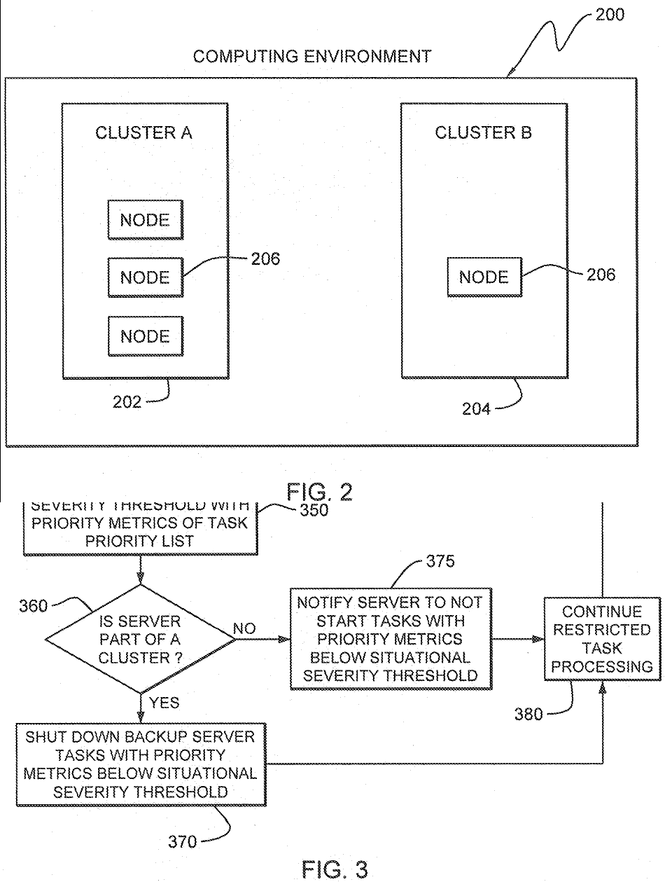

Consider two servers that are clustered, server A and server B. In a first scenario, server A fails, leaving no data for server B. Server B notices the loss of server A and thus starts to block (i.e., shutdown or pause) non-essential tasks (in accordance with the logic described below with reference to FIG. 3), such as synchronization of mail replicas. Server B gains additional CPU cycles doing this. The extra CPU cycles will be consumed by additional users signing on or failing over to server B. No user will notice that server B has shutdown tasks to maintain mail replicas in synch, and most would not notice the loss of Agent Manager or other supporting server tasks for a short time.

In a second scenario, server A fails on a mail memo conversion on inbound SMTP mail. Server B is able to determine the failing task and shuts down only the SMTP task on itself (in accordance with the logic of FIG. 3). Thus, the facility presented herein takes incremental steps towards providing a more stable server environment (while that server might remain the single point of failure), yet minimizes the effect these actions will have on the majority of users of the computing environment.

As noted, FIG. 3 depicts one embodiment of server logic associated with dynamically adjusting operating level of server processing, in accordance with an aspect of the present invention. The dynamic adjustment facility begins 300 with monitoring for detection of server failure 310. If a failure at a server is detected, the failure is reported 320 (e.g., to a central location which tracks server failures) and one or more priority metrics of server tasks are dynamically updated to reflect a cause of the server failure, that is, if determinable 330. Any existing problem determination routine can be run to detect whether a failure can be attributed to a particular type of task. There are automatic applications known in the art today that perform this type of problem determination, such as various eService Service Agents included with International Business Machine Corporation's mid-level and mainframe machines, as well as the above-referenced Tivoli products offered by International Business Machines Corporation. If the problem is determinable (that is, the type of server task executing at the time of failure can be identified), then the priority metric associated with that server task(s) can be reduced to zero, or can be reduce by some predetermined amount (e.g., proportional to a determined confidence level in the identification of the cause of server failure). The object is to block future processing of the type of server task executing at the time of the failure to isolate the problem and potentially prevent the problem from reoccurring within the cluster.

A situational severity threshold is then determined 340 for the computing environment. As noted above, the situational severity threshold is characterized as a number or value used to rate the importance of the failure in comparison to the importance of maintaining the server(s), or parts of the server functioning. The value can be extracted into a percentile number if desired. The threshold value can be calculated initially based on administrator-weighted factors, such as time of day, number of users, SLA metrics, and required resources. As noted above, the administrator (or, alternatively, the system manufacturer) pre-specifies within a given computing environment configuration the factors and the importance of each factor in deriving the situational severity threshold.

The facility then compares the situational severity threshold with priority metrics for the multiple types of server tasks, which may be set forth in a task priority list 350. By way of example, a default priority list of server tasks is predefined by a server administrator (or, again, by the system manufacturer). In a mail server, this list might appears as follows:
Server Task (main task that accepts client connections)—100
Mail Routing Task—80
Replication Task—35
Virus Scanning Task—30
Index Update Task—25
Statistic Collection—20
Web Mail Task—15
Calendar Task—10

Upon server failure, the update priority metric(s) process 330 may result in one or more of the predefined priority metrics for the various types of server tasks being adjusted, i.e., assuming that the executing task(s) at time of server failure can be identified. Suppose in this example that the failure is determined to be caused by a router. The router's priority metric is reduced by, for example, a predetermined amount (which could be proportional to the determined failure confidence label, i.e., how likely it was indeed the router's fault that the server failed). For instance, the router priority may be dropped to 50.

The situational severity threshold, automatically determined using any desired algorithm employing the weighted factors cited above, is used as a cutoff threshold to block processing of certain types of server tasks. By way of example, assume that there are three critical factors (SLA, Time of Day, number of users served) weighted equally, each factor determining ⅓ of the situational severity threshold. These factors can thus be rated from 0-33. Suppose 90% of the SLA downtime for the month has already been reached, resulting in a score of approximately 30 (33×0.9). Also, suppose that the server failure occurs at 11:00 AM, which is in the middle of prime shift, providing a score of 33 for that factor. Further, suppose that this server serves the second most user of the ten servers within the environment. This can be quantified as the 80^{th} percentile, contributing a score of approximately 26 (33×0.8). The composite score or situational severity threshold for this example is thus 89. Thus, only the server task type with a priority metric higher, i.e., the main task that accepts client connections, will be allowed to run, thereby keeping server task processing at a minimum, and most likely ensuring sufficient availability/up time since end users can still access their mail. As will be apparent from the above-noted considerations for determining the situational severity threshold, the threshold changes with time and computing environment conditions.

Continuing with the logic of FIG. 3, after comparing the situational severity threshold with the priority metrics of the multiple types of server tasks, the logic determines whether the server at issue is part of a cluster 360. If “no”, then the server is assumed (in this example) to be in a standalone computing environment, and is assumed to be the server having the failure. Thus, the server is notified to not start tasks with priority metrics below the situational severity threshold 375. The server then initializes or remains operational in a restricted task processing mode 380.

If the server at issue is part of a clustered computing environment, then it is assumed that the server is a backup server to a primary server having the failure. The logic then shuts down backup server tasks with priority metrics below the determined situational severity threshold 370. After blocking the server tasks with lower priority metrics, the backup server continues to run in a restricted task processing mode 380.

The detailed description presented above is discussed in terms of program procedures executed on a computer, a network or a cluster of computers. These procedural descriptions and representations are used by those skilled in the art to most effectively convey the substance of their work to others skilled in the art. They may be implemented in hardware or software, or a combination of the two.

A procedure is here, and generally, conceived to be a sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are automatic machine operations. Useful machines for performing the operations of the present invention include general purpose digital computers or similar devices.

Each step of the method may be executed on any general computer, such as a mainframe computer, personal computer or the like and pursuant to one or more, or a part of one or more, program modules or objects generated from any programming language, such as C++, Java, Fortran or the like. And still further, each step, or a file or object or the like implementing each step, may be executed by special purpose hardware or a circuit module designed for that purpose.

Aspects of the invention are preferably implemented in a high level procedural or object-oriented programming language to communicate with a computer. However, the inventive aspects can be implemented in assembly or machine language, if desired. In any case, the language may be a compiled or interpreted language.

The invention may be implemented as a mechanism or a computer program product comprising a recording medium. Such a mechanism or computer program product may include, but is not limited to CD-ROMs, diskettes, tapes, hard drives, computer RAM or ROM and/or the electronic, magnetic, optical, biological or other similar embodiment of the program. Indeed, the mechanism or computer program product may include any solid or fluid transmission medium, magnetic or optical, or the like, for storing or transmitting signals readable by a machine for controlling the operation of a general or special purpose programmable computer according to the method of the invention and/or to structure its components in accordance with a system of the invention.

The invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another environment (such as the clustered computing environment). The system may be specially constructed for the required purposes to perform, for example, the method steps of the invention or it may comprise one or more general purpose computers as selectively activated or reconfigured by a computer program in accordance with the teachings herein stored in the computer(s). The procedures presented herein are not inherently related to a particular computing enviromment. The required structure for a variety of these systems will appear from the description given.

Again, the capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of dynamically adjusting operating level of server processing within a computing environment, the computing environment including one or more servers processing multiple types of server tasks, the method comprising:
responsive to detecting failure at a server of the computing environment, determining a situational severity threshold for continued computing environment task processing;
comparing the situational severity threshold with priority metrics for the multiple types of server tasks processed by the computing environment; and
blocking server processing of one or more types of server tasks having a priority metric below the situational severity threshold.

2. The method of claim 1, further comprising dynamically adjusting at least one priority metric associated with at least one type of server task of the multiple types of server tasks to reflect a cause of the failure of the server, the dynamically adjusting occurring prior to the comparing and the blocking.

3. The method of claim 1, wherein the dynamically adjusting comprises automatically updating the at least one priority metric of at least one type of server task of the multiple types of server tasks in a task priority list to reflect a cause of the failure at the server, the task priority list comprising a defined priority metric for each type of server task of the multiple types of server tasks processed by the computing environment.

4. The method of claim 3, wherein the automatically updating comprises automatically reducing the priority metric of the at least one type of server task to inhibit processing thereof responsive to the comparing of the situational severity threshold with the priority metrics and the blocking server processing of the one or more types of server tasks.

5. The method of claim 4, wherein the automatically reducing of the priority metric of the at least one type of server task comprises reducing the priority metric by an amount proportional to a determined confidence level of an identification of a cause of the failure at the server being execution of the at least one type of server task.

6. The method of claim 3, wherein the priority metric of each type of task is derived, in part, from a number of resources required by the type of task, and a historic risk level of the type of task, derived from how often the type of task has caused server failure in the past, and wherein the method further comprises predefining a priority metric for each type of server task in the task priority list, the automatically updating comprising automatically reducing at least one predefined priority metric of the at least one type of server task to reflect the cause of the failure at the server.

7. The method of claim 1, wherein the computing environment comprises a server in a standalone computing environment, and the detected failure is at the server, and wherein the blocking comprises continuing task processing by the server in a restricted task processing mode wherein only critical task processing of the computing environment above the situational severity threshold is maintained.

8. The method of claim 1, wherein the computing environment comprises a cluster of servers comprising at least the server having the detected failure and a backup server thereto, and wherein the method further comprises transitioning server processing of tasks to the backup server responsive to detection of the failure, and wherein the blocking comprises blocking task processing at the backup server having a priority metric below the situational severity threshold, thereby ensuring critical task processing at the backup server.

9. The method of claim 1, wherein the blocking further comprises determining whether the failing server is part of a cluster, and if so, shutting down a backup server's processing of tasks with priority metrics below the situational severity threshold, otherwise, notifying the server having the failure to block processing of tasks with priority metrics below the situational severity threshold, and continuing restricted task processing at the server having the failure.

10. The method of claim 1, wherein determining the situational severity threshold comprises rating the server failure in comparison with importance of maintaining server processing, and wherein the rating comprises calculating the situational severity threshold employing a plurality of administrator-weighted factors, the administrator-weighted factors including at least some of: time of day, predefined server service level commitments, status of the failing server, and number of current users of the one or more servers of the computing environment.

11. A system of adjusting operating level of server processing within a computing environment, the computing environment including one or more servers processing multiple types of server tasks, the system comprising:
means for determining a situational severity threshold for continued computing environment task processing by the one or more servers responsive to detecting failure at a server of the computing environment;
means for comparing the situational severity threshold with priority metrics, each priority metric being associated with a different type of server task of the multiple types of server tasks processed by the computing environment; and
means for blocking processing of one or more types of server tasks having a priority metric below the situational severity threshold.

12. The system of claim 11, further comprising means for dynamically adjusting at least one priority metric associated with at least one type of server task of the multiple types of server tasks to reflect a cause of the failure of the server, the dynamically adjusting occurring prior to the comparing and the blocking.

13. The system of claim 12, wherein the means for dynamically adjusting comprises means for automatically reducing the priority metric of the at least one type of server task to inhibit processing thereof responsive to the comparing of the situational severity threshold with the priority metrics and the blocking server processing of the one or more types of server tasks.

14. The system of claim 13, wherein the means for automatically reducing of the priority metric of the at least one type of server task comprises means for reducing the priority metric by an amount proportional to a determined confidence level of an identification of a cause of the failure at the server being execution of the at least one type of server task.

15. The system of claim 14, wherein the priority metric of each type of task is derived, in part, from a number of resources required by the type of task, and a historic risk level of the type of task, derived from how often the type of task has caused server failure in the past, and wherein the system further comprises means for predefining a priority metric for each type of server task in the task priority list, the means for automatically updating comprising means for automatically reducing at least one predefined priority metric of the at least one type of server task to reflect the cause of the failure at the server.

16. The system of claim 11, wherein the means for blocking further comprises means for determining whether the failing server is part of a cluster, and if so, for shutting down a backup server's processing of tasks with priority metrics below the situational severity threshold, otherwise, for notifying the server having the failure to block processing of tasks with priority metrics below the situational severity threshold, and for continuing restricted task processing at the server having the failure.

17. The system of claim 11, wherein the means for determining the situational severity threshold comprises means for rating the server failure in comparison with importance of maintaining server processing, and wherein the means for rating comprises means for calculating the situational severity threshold employing a plurality of administrator-weighted factors, the administrator-weighted factors including at least some of: time of day, predefined server service level commitments, status of the failing server, and number of current users of the one or more servers of the computing environment.

18. At least one program storage device readable by a computer, tangibly embodying at least one program of instructions executable by the computer to perform a method of adjusting operating level of server processing within a computing environment, the computing environment including one or more servers processing multiple types of server tasks, the method comprising:
responsive to detecting failure at a server of the computing environment, determining a situational severity threshold for continued computing environment task processing;
comparing the situational severity threshold with priority metrics for the multiple types of server tasks processed by the computing environment; and
blocking server processing of one or more types of server tasks having a priority metric below the situational severity threshold.

19. The at least one program storage device of claim 18, further comprising dynamically adjusting at least one priority metric associated with at least one type of server task of the multiple types of server tasks to reflect a cause of the failure of the server, the dynamically adjusting occurring prior to the comparing and the blocking.

20. The at least one program storage device of claim 19, wherein the dynamically adjusting of the at least one priority metric associated with the at least one type of server task comprises automatically reducing the priority metric by an amount proportional to a determined confidence level of an identification of a cause of the failure at the server being execution of the at least one type of server task.

21. The at least one program storage device of claim 20, wherein the priority metric of each type of task is derived, in part, from a number of resources required by the type of task, and a historic risk level of the type of task, derived from how often the type of task has caused server failure in the past, and wherein the method further comprises predefining a priority metric for each type of server task in the task priority list, the automatically reducing comprising automatically reducing at least one predefined priority metric of the at least one type of server task to reflect the cause of the failure at the server.

22. The at least one program storage device of claim 18, wherein the blocking further comprises determining whether the failing server is part of a cluster, and if so, shutting down a backup server's processing of tasks with priority metrics below the situational severity threshold, otherwise, notifying the server having the failure to block processing of tasks with priority metrics below the situational severity threshold, and continuing restricted task processing at the server having the failure.

23. The at least one program storage device of claim 18, wherein determining the situational severity threshold comprises rating the server failure in comparison with importance of maintaining server processing, and wherein the rating comprises calculating the situational severity threshold employing a plurality of administrator-weighted factors, the administrator-weighted factors including at least some of: time of day, predefined server service level commitments, status of the failing server, and number of current users of the one or more servers of the computing environment.
